(19) United States
(12) Patent Application Publication
(10) Pub. No.: US 2025/0140049 A1
(43) Pub. Date: May 1, 2025

(54) MANAGEMENT SYSTEM, CONTROL APPARATUS, AND CONTROL METHOD

(71) Applicant: NEC Corporation, Minato-ku, Tokyo (JP)

(72) Inventors: Hiromi MUTO, Tokyo (JP); Rieko UENO, Tokyo (JP); Hidekazu NAGAOKA, Tokyo (JP)

(73) Assignee: NEC Corporation, Minato-ku, Tokyo (JP)

(21) Appl. No.: 18/834,342

(22) PCT Filed: Feb. 4, 2022
(86) PCT No.: PCT/JP2022/004560

§ 371 Date: Jul. 30, 2024

(51) Int. Cl. G07C 9/30

(52) U.S. Cl. CPC G07C 9/30; G07C 2209/08

(57) ABSTRACT

An object is to provide a management system capable of preventing efficiency of work using a mobile body from reducing. The management system according to the present disclosure includes: acquisition means (11) for acquiring information regarding work carried out by the mobile body and a time when the work is carried out; specification means (12) for specifying a prohibited area which a person is not allowed to enter in accordance with work; and control means (13) for performing control for regulating the entry of a person into the specified prohibited area in accordance with the time when the work is carried out.

### TECHNICAL FIELD

The present disclosure relates to a management system, a control apparatus, and a control method.

### BACKGROUND ART

In a construction site or a warehouse of a distribution center or the like, people and mobile bodies such as Automatic Guided Vehicles (AGVs) or forklifts may carry out work at the same time. Therefore, it is required to improve safety in the site where the people and the mobile bodies may perform work at the same time. Patent Literature 1 and 2 relate to a technique for avoiding mobile bodies and people coming into contact with each other by setting a dangerous area near the mobile body.

Patent Literature 1 discloses a configuration example of an alert output system that outputs an alert when there is a worker not communicating with an operator who operates a construction machine or an administrator of a work group in an attention required area of a construction site. Patent Literature 1 discloses displaying a message on a terminal held by the operator who operates the construction machine in the attention required area indicating that the worker is not communicating with the operator. The attention required area may be, for example, an area near a construction machine which performs a transporting work, or may be a lower part of a load when a construction machine unloads the load from a high place. Patent Literature 2 discloses setting an entry prohibited area set near a working machine in accordance with the content of work carried out by a worker. When a person enters the working area, the working machine is stopped or the speed of the operation of this working machine is reduced. When the working machine is stopped, workers near the working machine are notified, by a warning buzzer or the like, that the working machine has been stopped.

### CITATION LIST

### Patent Literature

[Patent Literature 1] Japanese Unexamined Patent Application Publication No. 2020-135531
[Patent Literature 2] Japanese Unexamined Patent Application Publication No. 2003-105807

### SUMMARY OF INVENTION

### Technical Problem

However, in Patent Literature 1, since workers can enter the attention required area, the operator of the construction machine needs to perform work without coming in contact with any of the workers. In this case, the operator of the construction machine carries out the work while being careful to avoid coming into contact with the workers, which causes a problem that the efficiency of the work performed using the construction machine may be reduced.

One of the objects of the present disclosure is to provide a management system, a control apparatus, and a control method capable of preventing efficiency of work using a mobile body from being reduced.

### Solution to Problem

A management system according to a first aspect of the present disclosure includes: acquisition means for acquiring information on work carried out by a mobile body and a time when the work is carried out; specification means for specifying a prohibited area which a person is not allowed to enter in accordance with the work; and control means for performing control for regulating the entry of a person into the specified prohibited area in accordance with the time when the work is carried out.

A control apparatus according to a second aspect of the present disclosure includes: acquisition means for acquiring information on work carried out by a mobile body and a time when the work is carried out; specification means for specifying a prohibited area which a person is not allowed to enter in accordance with the work; and control means for performing control for regulating the entry of a person into the specified prohibited area in accordance with the time when the work is carried out.

A control method according to a third aspect of the present disclosure includes: acquiring information regarding work carried out by a mobile body and a time when the work is carried out; specifying a prohibited area which a person is not allowed to enter in accordance with the work; and performing control for regulating the entry of a person into the specified prohibited area in accordance with the time when the work is carried out.

### Advantageous Effects of Invention

According to the present disclosure, it is possible to provide a management system, a control apparatus, and a control method capable of reducing the possibility of a mobile body and a person coming into contact with each other.

### BRIEF DESCRIPTION OF DRAWINGS

FIG. 1 is a configuration diagram of a management system according to a first example embodiment;

FIG. 2 is a diagram showing a flow of processing for executing regulating measures according to the first example embodiment;

FIG. 3 is a configuration diagram of a management system according to a second example embodiment;

FIG. 4 is a diagram showing information managed in a management unit according to the second example embodiment;

FIG. 5 is a diagram showing information managed in the management unit according to the second example embodiment;

FIG. 6 is a diagram showing a prohibited area according to the second example embodiment;

FIG. 7 is a configuration diagram of a management system according to a third example embodiment;

FIG. 8 is a diagram showing a flow of processing for executing regulating measures according to the third example embodiment; and

FIG. 9 is a configuration diagram of a control apparatus according to each of the example embodiments.

### EXAMPLE EMBODIMENT

### First Example Embodiment

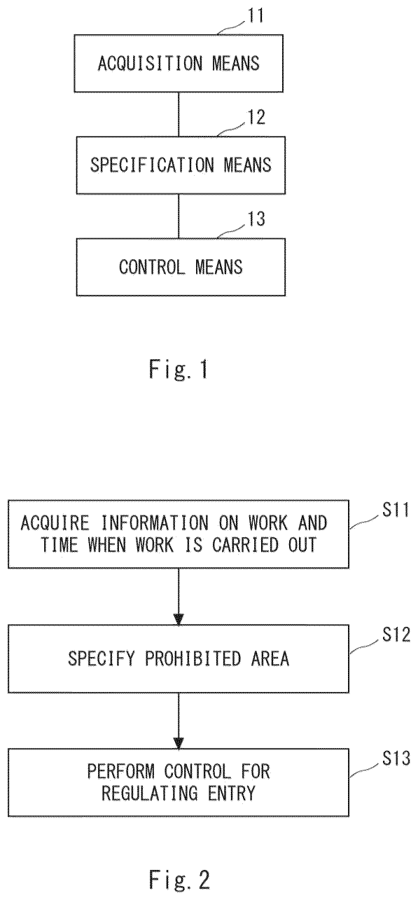

Hereinafter, with reference to the drawings, example embodiments of the present invention will be described. With reference to FIG. 1, a configuration example of a management system according to a first example embodiment will be described. The management system includes acquisition means 11, specification means 12, and control means 13. The acquisition means 11, the specification means 12, and the control means 13 may each be software or a module whose processing is executed by a processor executing a program stored in a memory. Alternatively, the acquisition means 11, the specification means 12, and the control means 13 may each be hardware such as a circuit or a chip.

The acquisition means 11, the specification means 12, and the control means 13 are included in a computer apparatus. The acquisition means 11, the specification means 12, and the control means 13 may be included in computer apparatuses different from each other or may be provided in one computer apparatus. Alternatively, two or more elements of the acquisition means 11, the specification means 12, and the control means 13 may be provided in one computer apparatus. The computer apparatus is an apparatus that operates by the processor executing the program stored in the memory.

The acquisition means 11 acquires information on work carried out by a mobile body and a time when the work is carried out. The mobile body may be equipment that moves by a driver who performs operation directly or performs a remote operation, or may be equipment that autonomously moves. The mobile body may be, for example, a forklift, an Automatic Guided Vehicle (AGV), or a backhoe. In order to implement the remote operation, an actuator may be attached to an operating mechanism of a vehicle such as a forklift or a backhoe, and the remote operation terminal may transmit an operation instruction signal to the computer apparatus that controls the actuator via a network. The mobile body may move, for example, in a warehouse, a factory, a plant, a manufacturer, or a distribution center.

The work may be, for example, reception of loads, dispatch of loads, loading and unloading, conveyance of loads, replenishment of loads, or stock-taking of loads. The conveyance of loads may also be referred to as a movement of loads. For example, one mobile body may carry out a plurality of kinds of work, such as loading, unloading, and conveyance of loads, or one mobile body may perform only one kind of work. In a warehouse, for example, a plurality of mobile bodies may carry out the work. That is, the work may be work carried out by one mobile body or by a plurality of mobile bodies. Further, the acquisition means 11 may acquire plan information including information regarding the work carried out by the mobile body and a time when the work is carried out. In the plan information, a place where the loads are stored may be associated with the work for receiving loads, and a place where a mobile body picks up loads, that is, a pickup place may be associated with the work for dispatching loads. Further, in the plan information, a place to which loads are conveyed, a place where an inspection of loads is carried out, a place where loads are temporarily placed or the like may be associated with the work of conveying loads.

Here, in the reception of loads, the loads or products are placed on a shelf, or the loads are placed or piled up in a specified place in a factory or the like. In the dispatching of loads or products, the loads or products are picked up from a shelf or the loads are transported from a specified place. Further, in the movement of loads, the loads or palettes on which loads are placed are carried from one place to another place. Further, in the replenishment of loads, the loads are moved from one shelf to another shelf. Further, in stock-taking, the loads are picked up from a shelf and the number of the loads are checked.

The time when the work is carried out may be, for example, a time of day when a mobile body performs loading and unloading, and a time of day when the mobile body performs conveyance of loads. Alternatively, the time when the work is carried out may be a time when the mobile body starts the loading and unloading and a time when it stops the same, a time when the mobile body starts the conveyance of loads and a time when it stops the same, etc.

Besides information indicating the work and the time when the work is carried out, the plan information may include, for example, identification information on a mobile body, the number of mobile bodies to be operated, etc. The plan information may further include reception/dispatch information indicating information on products brought into a warehouse and information on products carried out from the warehouse. The information on the products may include the names of the products and may further include the number of products to be received or dispatched. Further, the plan information may include location information indicating how many products are in stock and at what location in the warehouse the products are. The plan information may further include batch time information for starting the dispatch work for each unit at which the work is collectively carried out, such as information on the customer to which products are delivered or the direction in which the products are delivered.

The specification means 12 specifies a prohibited area which people are not allowed to enter in accordance with the work. The work area where the mobile body carries out the work may be specified as the prohibited area which people are not allowed to enter. The work area where the mobile body carries out the work may be specified based on the work carried out by the mobile body.

The work area may be an area including an area where a mobile body moves. The area where the mobile body moves can also be referred to as an area including a flow line of the mobile body. The work area may be, for example, one section in a case where a space in the warehouse is divided into a plurality of sections or may be an area where some sections are combined with each other. The section may be, for example, one of a plurality of grids obtained by dividing map information in the warehouse or may be an area obtained by combining some grids.

The work carried out by the mobile body and the work area may be associated with each other in advance and may be managed in a database. Alternatively, the plan information acquired by the acquisition means 11 may include information indicating the work area along with the information indicating the work.

The specification means 12 may specify or set one work area as a prohibited area based on the time when the work is carried out by the mobile body. For example, one work area may be set as the prohibited area in the morning hours since the work is carried out by the mobile body, whereas the same work area may not be set as the prohibited area in the afternoon hours since the work is not carried out by the mobile body. The work area that is not set as the prohibited area may be referred to as, for example, a normal area. In the normal area, the work may be carried out by a person, not by the mobile body. That is, the specification means 12 may determine whether or not one work area should be set as the prohibited area depending on time. In other words, the specification means 12 may dynamically switch one work area between the prohibited area and the normal area.

The control means 13 performs, in accordance with the time when the work is carried out, control for regulating the entry of people into the prohibited area that has been specified. The control for regulating the entry of people into the prohibited area may be interrupting entry of people into the prohibited area. As the control for regulating the entry of people into the prohibited area, the control means 13 transmits a control signal for regulating entry of people to equipment installed near the prohibited area. The equipment that has received the control signal starts the operation in accordance with the control signal. The equipment installed near the prohibited area may be equipment installed inside the prohibited area or may be equipment near the prohibited area among a plurality of pieces of equipment installed outside the prohibited area. The control for regulating the entry of people into the prohibited area may be, for example, locking a door installed in the boundary between the prohibited area and the normal area. Alternatively, the control for regulating the entry of people into the prohibited area may be lowering a bar installed in the boundary between the prohibited area and the normal area. Alternatively, the control for regulating the entry of people into the prohibited area may be turning on a lighting device installed in the prohibited area or a door or the like leading to the prohibited area. The lighting device may be referred to as, for example, a warning light, a rotating light, a signal beacon, or patlite (registered trademark). The lighting device may be installed in a position where people entering the prohibited area can visually recognize this lighting device. Alternatively, the control for regulating the entry of people into the prohibited area may be displaying a message indicating that entry to the prohibited area is prohibited on a display apparatus installed in the prohibited area or on a wall or the like of the boundary between the prohibited area and the normal area. Alternatively, the control for regulating the entry of people into the prohibited area may be transmitting a message indicating that entry to the prohibited area is prohibited to a terminal device held by the worker.

Next, with reference to FIG. 2, a flow of processing for executing regulatory control according to the second example embodiment will be described. First, the acquisition means 11 acquires information on the work carried out by the mobile body and the time when the work is carried out (S11). Next, the specification means 12 specifies the prohibited area which people are not allowed to enter in accordance with the information indicating the work (S12). Next, the control means 13 performs control for regulating the entry of people into the prohibited area (S13).

As described above, the management system according to the first example embodiment is able to specify the prohibited area in accordance with the work carried out by the mobile body. Further, the management system performs control for regulating the entry of people into the prohibited area. Accordingly, it is possible to reduce the possibility that people enter the prohibited area. As a result, it is possible to reduce the possibility of a person and a mobile body coming into contact with each other in the prohibited area. Further, when the management system according to the first example embodiment is not used, if a worker enters an area near the mobile body by carelessness, the work may be delayed because the operation of the mobile body is restricted for safety reasons. On the other hand, when the management system according to the first example embodiment is used, it is possible to prevent workers from entering an area near the mobile body, whereby it is possible to prevent the work from delaying.

### Second Example Embodiment

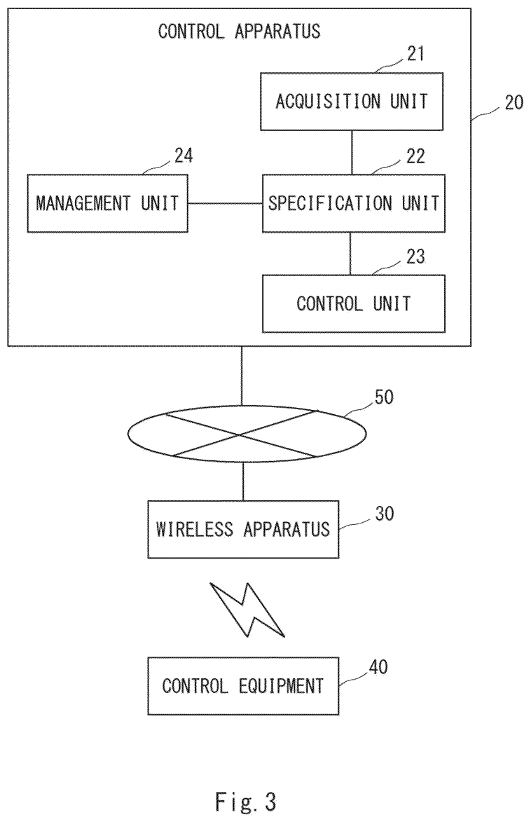

Next, with reference to FIG. 3, a configuration example of a management system according to a second example embodiment will be described. The management system shown in FIG. 3 includes a control apparatus 20, a wireless apparatus 30, and a control equipment 40. The control apparatus 20 is a computer apparatus that includes functions performed in the acquisition means 11, the specification means 12, and the control means 13 described with reference to FIG. 1.

The control apparatus 20 is connected to the wireless apparatus 30 via a network 50. The network 50 is, for example, an IP network, and may be the Internet. Alternatively, the network 50 may be an intra-enterprise network managed by an enterprise or the like.

The wireless apparatus 30 is an apparatus that performs wireless communication such as wireless Local Area Network (LAN) communication.

The wireless apparatus 30 may be referred to as, for example, a main apparatus that executes wireless LAN communication. Alternatively, the wireless apparatus 30 may perform wireless communication in accordance with communication standards other than wireless LAN.

The control equipment 40, which is an apparatus having a communication function for performing wireless communication, may be referred to as, for example, a sub apparatus that executes wireless LAN communication. The control equipment 40 may be, for example, a warning light having a communication function or may be a door capable of performing lock management by a remote operation via the network 50. Alternatively, the control equipment 40 may be a display apparatus that displays a message in accordance with a signal received via the network 50.

While FIG. 3 shows a state in which the control equipment 40 is connected to the network 50 via a wireless communication line, the control equipment 40 may be connected to the network 50 without using the wireless apparatus 30.

Next, a configuration example of the control apparatus 20 will be described. The control apparatus 20 includes an acquisition unit 21, a specification unit 22, a control unit 23, and a management unit 24. The acquisition unit 21 corresponds to the acquisition means 11, the specification unit 22 corresponds to the specification means 12, and the control unit 23 corresponds to the control means 13. The acquisition unit 21, the specification unit 22, and the control unit 23 may each be software or a module whose processing is executed by a processor executing a program stored in a memory. Alternatively, the acquisition unit 21, the specification unit 22, and the control unit 23 may be hardware such as a circuit or a chip. The management unit 24 may be a memory that records data. The management unit 24 may be a memory embedded in the control apparatus 20 or may be a memory externally attached to the control apparatus 20. In the following, detailed descriptions of operations or functions of the acquisition unit 21, the specification unit 22, and the control unit 23 similar to those of the acquisition means 11, the specification means 12, and the control means 13 will be omitted.

The acquisition unit 21 acquires map information indicating the place where the mobile body moves along with the plan information of the mobile body, these information items being input by the administrator via an input interface. Alternatively, the acquisition unit 21 may acquire the plan information and the map information from the computer apparatus operated by an administrator via the network 50.

The map information may include, when the mobile body moves in the warehouse, information indicating the position of the warehouse, the shape of the warehouse, or the structure inside the warehouse. The information indicating the structure inside the warehouse may be, for example, information indicating walls, shelves, machine equipment, passageways, and so on. Further, the map information may indicate a current location of a mobile body such as a forklift.

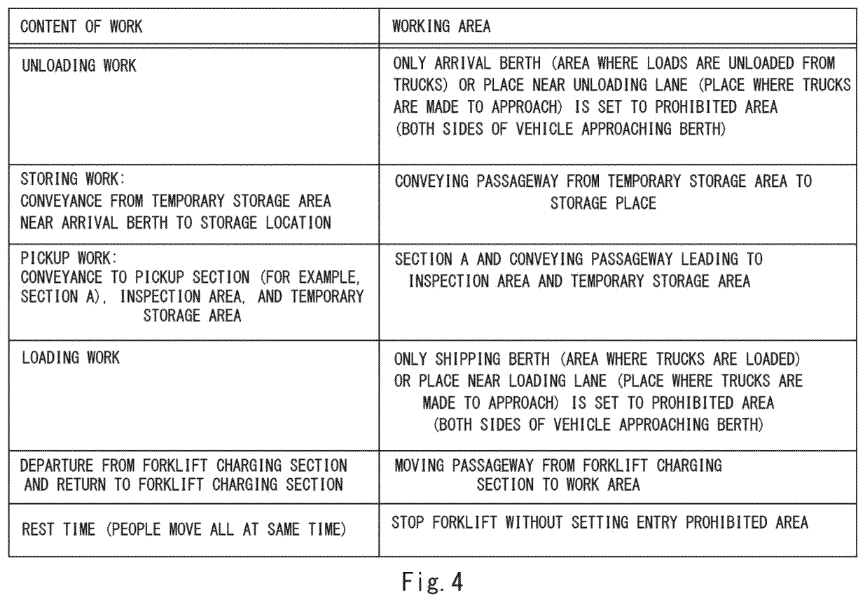

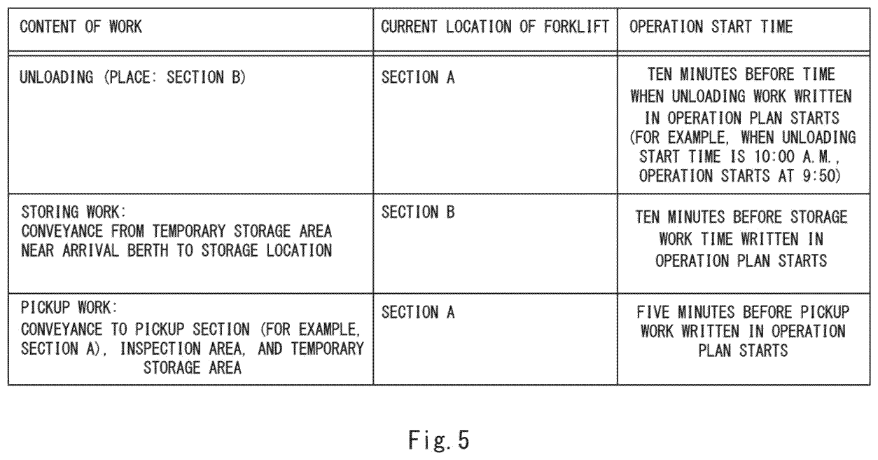

The management unit 24 manages the content of the work and the work area in association with one another. With reference to FIG. 4, information managed by the management unit 24 will be described. FIG. 4 shows that the content of the work and the work area are managed in such a way that they are associated with each other. The content of the work and the work area may be managed in a form of a database. The plan information includes at least one kind of work listed in the content of the work shown in FIG. 4.

Each area listed in the work area is associated with work. For example, when the content of the work is unloading work, the work area is limited to an arrival berth or a place near an unloading lane. The arrival berth is an area that is required when loads are unloaded from trucks and the unloading lane is a place which trucks are made to approach at the time of unloading. The place near the unloading lane may be, for example, a vehicle approaching berth and both sides of the vehicle approaching berth.

When the content of the work is storing work, the work area is a conveying passageway from a temporary storage area of the loads to the storage place. The temporary storage area may be, for example, the arrival berth or a place near the arrival berth.

When the content of the work is pickup work, the work area is a section A where the pickup is carried out, and a convey passageway leading to an inspection area and a temporary storage area. When the content of the work is loading work, the work area is only a shipping berth or a place near a loading lane. The shipping berth is an area required for loading trucks, and the loading lane is a place where trucks are made to approach at the time of loading. The place near the loading lane may be, for example, a vehicle approaching berth and both sides of the vehicle approaching berth.

When the content of the work is departure from a charging section and return to the charging section of a forklift, the work area is a moving passageway from the forklift charging section to the work area. Further, when the content of the work is a rest time, forklifts are stopped and therefore the work area is not set.

The specification unit 22 extracts the information indicating the work area associated with the information indicating the work included in the plan information.

The specification unit 22 may update the information on the extracted work area using the map information. For example, when the specification unit 22 has extracted the work area associated with the unloading work, the specification unit 22 may specify the arrival berth and the place near the unloading lane, shown in the map information, as the work area. The specification unit 22 may specify the specified work area using identification information of grids or may specify the specified work area using the latitude and the longitude.

Further, the management unit 24 may manage the content of the work, the current location of the forklift, and the operation start time of the forklift in association with one another. FIG. 5 shows the information managed by the management unit 24. For example, FIG. 5 shows that, when the current location of the forklift is a section A and the work area of the unloading work is a section B, the forklift moves from the section A to the section B. FIG. 5 further shows that, when the forklift moves from the section A to the section B to perform the unloading work, the operation start time of the forklift is ten minutes before the time when the unloading work is carried out included in the plan information. It is assumed here that the time when the unloading work is carried out included in the plan information is from ten to eleven. In this case, the specification means 12 may specify that the time when the forklift starts moving from the section B to the section A is 9:50 a.m., which is ten minutes before the time when the unloading work is carried out.

The specification unit 22 specifies the control start time when the control is started using the specified work area and the operation start time of the mobile body. For example, the specification unit 22 may continue to perform control on the specified work area until the time when the work is carried out expires from a control start time, which is an operation start time of the mobile body. The time when the control is ended is set to be a control end time. Alternatively, the specification unit 22 may continue to perform control on the specified work area until the time when the work is carried out expires from a control start time, which is a time a few minutes before the operation start time of the mobile body. The “few minutes before” may be a time set by an administrator or the like, such as five minutes before or ten minutes before, or may be any predetermined time. The work area from the control start time to the control end time when the control is ended is a prohibited area. In this manner, it is possible to reduce the possibility that a person is present in the work area at the operation start time of the mobile body by starting control a few minutes before the operation start time of the mobile body and setting the work area as the prohibited area.

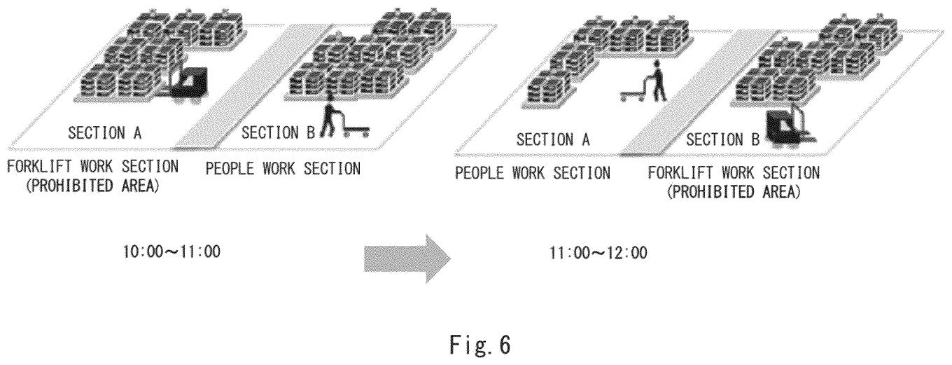

Referring now to FIG. 6, the prohibited area and the normal area will be described. FIG. 6 shows that the section A is a work section of forklifts and the section B is a work section of people from ten to eleven. In this case, the section A is set to be the prohibited area from ten to eleven and the section B is set to be the normal area from ten to eleven. Further, the section A is the work section of people and the section B is the work section of the forklifts from eleven to twelve. In this case, the section B is set to be the prohibited area from eleven to twelve and the section A is set to be the normal area from eleven to twelve. It is determined whether each section is set to the prohibited area or the normal area depending on the time of day.

Further, the prohibited area specified in the specification unit 22 may be changed in accordance with an instruction for making correction from the administrator. For example, the administrator may input instruction information for causing the prohibited area to be widen or narrowed down via an input interface after he/she checks information on the prohibited area displayed on the display used integrally with the control apparatus 20 or the display of the terminal device held by the administrator. The specification unit 22 receives the input instruction information and corrects or updates the prohibited area based on the instruction information. The administrator may input instruction information for correcting the time when the work area is set as the prohibited area. The administrator may refer to, for example, information included in the plan information and input instruction information indicating correction or the like regarding the prohibited area.

The control unit 23 transmits an instruction signal for indicating that control for regulating the entry of people into the prohibited area is to be performed to the control equipment 40. The control equipment 40 that performs control for regulating the entry of people into the prohibited area may be managed in the management unit 24 in association with the work area. For example, the control unit 23 may transmit the instruction signal to a warning light installed in the work area which is the prohibited area or a warning light installed in a passageway that mobile bodies or people pass when moving to the work area which is the prohibited area to cause the warning light to be lit. The warning light may be installed in a shelf, the ceiling, or the like. The control unit 23 may determine the warning light to be lit for each shelf. Alternatively, the control unit 23 may transmit the instruction signal to a system that manages a door installed in the work area which is the prohibited area to cause the door to be locked. Alternatively, the control unit 23 may transmit the instruction signal to the system that manages the warning light and the door.

The control unit 23 may transmit an instruction signal for indicating all the warning lights installed in the work area, which is the prohibited area, to be turned on, to a system that manages the warning lights. Alternatively, the control unit 23 may transmit an instruction signal indicating that some warning lights are to be turned on to the system that manages the warning lights. For example, the control unit 23 may transmit an instruction signal indicating that the warning light that is installed in a position close to the entrance of the work area is to be turned on and indicating that the warning light that is installed in a position located away from the entrance of the work area is not be turned off to the system that manages the warning lights. The place where the warning lights are installed may be managed, for example, in the management unit 24.

As described above, the control apparatus 20 according to the second example embodiment is able to change a section from the normal area to the prohibited section by setting the control start time in accordance with the operation start time of the mobile body, and to further change the section from the prohibited section to the normal area. Accordingly, the control apparatus 20 is able to set the prohibited area in accordance with the working plan of the mobile body in a logistics site where a work area of mobile bodies such as forklifts is changed frequently. Further, the control apparatus 20 performs control to regulate entry of people into the prohibited area. Therefore, even when the work area of the mobile bodies is changed frequently, it is possible to prevent people from entering the work area of the mobile bodies, whereby it is possible to reduce the possibility that mobile bodies come into contact with people.

### Third Example Embodiment

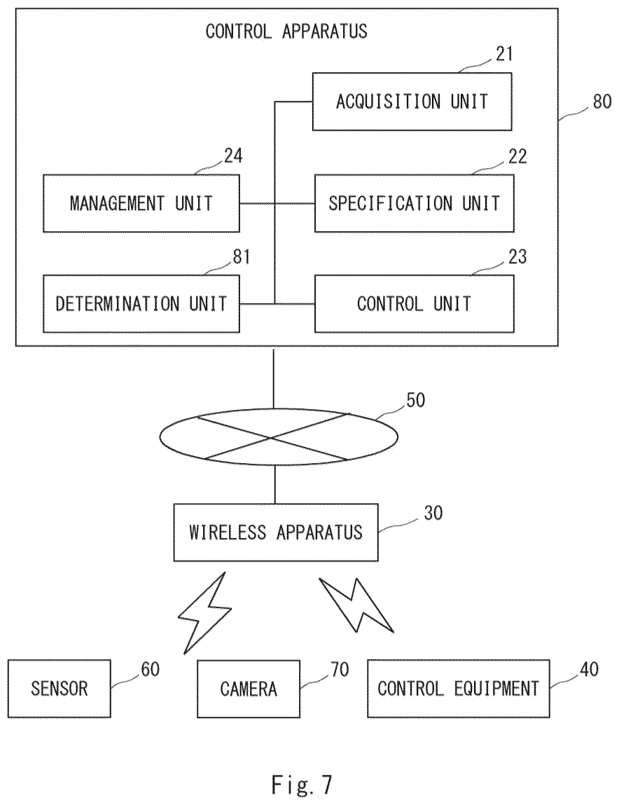

Next, with reference to FIG. 7, a configuration example of a management system according to a third example embodiment will be described. The management system shown in FIG. 7 has a configuration in which a sensor 60 and a camera 70 are added to the management system shown in FIG. 3 and a control apparatus 80 is used in place of the control apparatus 20. The control apparatus 80 has a configuration in which a determination unit 81 is added to the control apparatus 20. In the following, a configuration of FIG. 7 different from that of FIG. 3 will be mainly described and the configuration similar to that shown in FIG. 3 will not be described in detail.

At least one sensor 60 may be installed in the work area. Alternatively, the sensor 60 may be mounted on a mobile body. The sensor 60 is used to detect a person who is in the work area. The sensor 60 may be, for example, a motion sensor, a temperature sensor, or a voice sensor. The voice sensor detects, for example, a person who is present in the work area by detecting a voice of this person. Alternatively, the sensor 60 may be an infrared sensor. For example, the infrared sensor may be set in a boundary between the prohibited area and the normal area and detect the presence of a person who enters the prohibited area when the person passes through the infrared light. The sensor 60 transmits the sensed or detected information to the control apparatus 80 via the wireless apparatus 30 and the network 50. The sensor 60 may transmit information indicating the place where the sensor 60 is installed along with the sensed or detected information. Alternatively, when the control apparatus 80 manages the place where the sensor 60 is installed, the sensor 60 may transmit identification information of the sensor 60 along with the sensed or detected information.

Just like the sensor 60, at least one camera 70 may be installed in the work area. Alternatively, the camera 70 may be mounted on the mobile body. Alternatively, a plurality of cameras 70 may be installed in the work area in such a way that all the spaces in the work area can be photographed. The camera 70 transmits information on the captured images to the control apparatus 80 via the wireless apparatus 30 and the network 50. The image captured by the camera 70 may be either a moving image or a still image. For example, the camera 70 may capture an image when the sensor 60 has detected the presence of a person. The camera 70 may transmit information indicating the place where the camera 70 is installed along with the image information. Alternatively, when the control apparatus 80 manages the place where the camera 70 is installed, the control apparatus 80 may transmit identification information of the camera 70 along with the image information.

The acquisition unit 21 acquires information from at least one of the sensor 60 or the camera 70. The determination unit 81 specifies, when the determination unit 81 has acquired information from the sensor 60 that is present in the prohibited area specified in the specification unit 22, that a person is present in the prohibited area. Further, the determination unit 81 specifies, when the determination unit 81 has acquired image information from the camera 70 that is present in the prohibited area and detects a person by analyzing image information, that a person is present in the prohibited area. The determination unit 81 may specify that a person is present in the prohibited area only based on the information acquired by the sensor 60 or may specify that a person is present in the prohibited area only based on the image information acquired from the camera 70.

When it is specified in the determination unit 81 that a person is present in the prohibited area, the control unit 23 may unlock the door when a person leaves from the prohibited area in order to cause people to move outside the prohibited area. When a person enters the prohibited area, the door may not be unlocked. Alternatively, the control unit 23 may change the color of the warning light to a color that is used to send a notification indicating that a person is present in the prohibited area. Further, the control unit 23 may send the notification to a system or the like that manages the mobile body that a person is present in the prohibited area in order to stop the work carried out by the mobile body.

The determination unit 81 may change, when it is specified that a person is present in the prohibited area, the operation start time of the mobile body, and the working time included in the plan information. The determination unit 81 may change the control start time as well by changing the operation start time of the mobile body. For example, when it is specified that a person is present in the prohibited area, work carried out by the mobile body is delayed because the work carried out by the mobile body is stopped. Therefore, the determination unit 81 may change, when it is specified that a person is present in the prohibited area, the work end time indicated in the plan information in such a way that the work end time is delayed. Further, the determination unit 81 may delay the control start time or the operation start time of the mobile body in a work area where the mobile body works next time.

That is, the determination unit 81 may delay a timing when the current prohibited area is changed to the normal area, and further a timing when the work area where the mobile body works next time is changed to the prohibited area. The “current” is a timing when it is specified that a person is present in the prohibited area. In this manner, the determination unit 81 may change, when it is specified that a person is present in the prohibited area, the time of the entire work plan indicated by the plan information. The determination unit 81 may set, when it is specified that a person is present in the prohibited area, a predetermined period of time as the delayed time or may set a time input from an administrator as the delayed time.

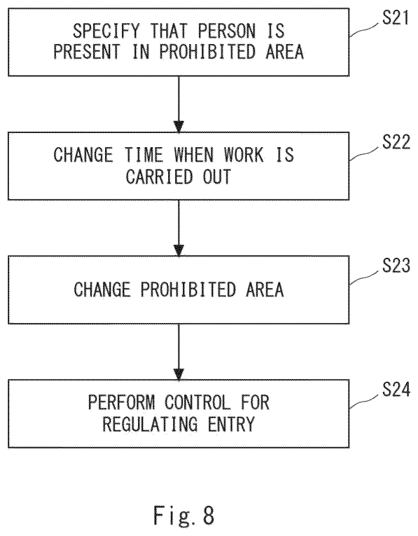

Next, with reference to FIG. 8, a flow of processing for executing regulatory control according to the third example embodiment will be described. First, the determination unit 81 specifies that a person is present in the prohibited area (S21). For example, the determination unit 81 specifies that a person is present in the prohibited area based on the information that the acquisition unit 21 has acquired from the sensor 60 or the camera 70.

Next, the determination unit 81 changes or updates the operation start time of the mobile body and the working time of the mobile body (S22). The determination unit 81 may set a predetermined time as a delayed time or may set time input from an administrator as a delayed time.

Next, the determination unit 81 changes a timing when the work area of the mobile body is changed from the normal area to the prohibited area or a timing when the work area of the mobile body is changed from the prohibited area to the normal area (S23). That is, the determination unit 81 changes the control start time and the control end time. The determination unit 81 delays, when the operation start time of the mobile body in one work area is delayed, the timing when this work area is set to be the prohibited area as well.

Next, the control unit 23 performs control on the prohibited area after the change for regulating the entry of people into the prohibited area (S24).

As described above, the management system according to the third example embodiment changes, when it is specified that a person is present in the prohibited area, the work start time of the mobile body and the working time of the mobile body. Accordingly, the timing when the work area is set to be the prohibited area is changed, and control for regulating the entry of people into the prohibited area may be performed on the prohibited area according to the schedule after the change.

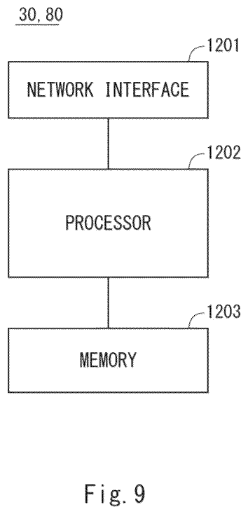

FIG. 9 is a block diagram showing a configuration example of the control apparatus 20 and the control apparatus 80 (hereinafter they will be referred to as the control apparatus 20 and so on) described in the aforementioned example embodiments. Referring to FIG. 9, the control apparatus 20 and so on include a network interface 1201, a processor 1202, and a memory 1203. The network interface 1201 may be used to communicate with the network node. The network interface 1201 may include, for example, a network interface card (NIC) in compliance with the IEEE 802.3 series. IEEE stands for Institute of Electrical and Electronics Engineers.

The processor 1202 loads software (a computer program) from the memory 1203 and executes this loaded software, thereby performing processing of the control apparatus 20 and so on described with reference to the flowchart in the above-described example embodiments. The processor 1202 may be, for example, a microprocessor, a Micro Processing Unit (MPU), or a Central Processing Unit (CPU). The processor 1202 may include a plurality of processors.

The memory 1203 is composed of a combination of a volatile memory and a non-volatile memory. The memory 1203 may include a storage located apart from the processor 1202. In this case, the processor 1202 may access the memory 1203 via an Input/Output (I/O) interface (not shown).

In the example shown in FIG. 9, the memory 1203 is used to store software modules. The processor 1202 loads these software modules from the memory 1203 and executes these loaded software modules, thereby performing processing of the control apparatus 20 and so on described in the aforementioned example embodiments.

As described with reference to FIG. 9, each of the processors included in the control apparatus 20 and so on in the above-described example embodiments executes one or more programs including instructions for causing a computer to execute the algorithm described with reference to the drawings.

In the aforementioned examples, the program includes instructions (or software codes) that, when loaded into a computer, cause the computer to perform one or more of the functions described in the example embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals. Note that the present disclosure is not limited to the above-described example embodiments and may be changed as appropriate without departing from the scope of the present disclosure.

The whole or part of the example embodiments disclosed above can be described as, but not limited to, the following supplementary notes.

### (Supplementary Note 1)

A management system comprising:
acquisition means for acquiring information on work carried out by a mobile body and a time when the work is carried out;
specification means for specifying a prohibited area which a person is not allowed to enter in accordance with the work; and
control means for performing control for regulating the entry of a person into the specified prohibited area in accordance with the time when the work is carried out.

### (Supplementary Note 2)

The management system according to Supplementary Note 1, wherein
the specification means specifies, in accordance with the time when the work is carried out, a control start time when the control is started, and
the control means starts the control from the specified control start time.

### (Supplementary Note 3)

The management system according to Supplementary Note 2, wherein the control start time is set, based on the time when the work is carried out, a predetermined time before the time when the work is carried out.

### (Supplementary Note 4)

The management system according to any one of Supplementary Notes 1 to 3, wherein the specification means specifies the prohibited area associated with the work based on the work.

### (Supplementary Note 5)

The management system according to any one of Supplementary Notes 1 to 4, wherein
the acquisition means acquires information indicating that a person is present in the prohibited area, and
the specification means changes the time when the work is carried out in accordance with the information indicating that the person is present in the prohibited area.

### (Supplementary Note 6)

The management system according to any one of Supplementary Notes 1 to 5, wherein the control means transmits, to equipment installed near the prohibited area, a control signal for regulating entry of a person.

### (Supplementary Note 7)

The management system according to any one of Supplementary Notes 1 to 6, wherein the control means turns on a lighting device installed near the prohibited area.

### (Supplementary Note 8)

The management system according to any one of Supplementary Notes 1 to 7, wherein the control means interrupts a path for entering the prohibited area.

### (Supplementary Note 9)

A control apparatus comprising:
acquisition means for acquiring information on work carried out by a mobile body and a time when the work is carried out;
specification means for specifying a prohibited area which a person is not allowed to enter in accordance with the work; and
control means for performing control for regulating the entry of a person into the specified prohibited area in accordance with the time when the work is carried out.

### (Supplementary Note 10)

The control apparatus according to Supplementary Note 9, wherein
the specification means specifies, in accordance with the time when the work is carried out, a control start time when the control is started, and
the control means starts the control from the specified control start time.

### (Supplementary Note 11)

The control apparatus according to Supplementary Note 9 or 10, wherein the specification means specifies the prohibited area associated with the work based on the work.

### (Supplementary Note 12)

The control apparatus according to any one of Supplementary Notes 9 to 11, wherein
the acquisition means acquires information indicating that a person is present in the prohibited area, and
the specification means changes the time when the work is carried out in accordance with the information indicating that the person is present in the prohibited area.

### (Supplementary Note 13)

The control apparatus according to any one of Supplementary Notes 9 to 12, wherein the control means transmits, to equipment installed near the prohibited area, a control signal for regulating entry of a person.

### (Supplementary Note 14)

The control apparatus according to any one of Supplementary Notes 9 to 13, wherein the control means turns on a lighting device installed near the prohibited area.

### (Supplementary Note 15)

A control method comprising:
acquiring information regarding work carried out by a mobile body and a time when the work is carried out;
specifying a prohibited area which a person is not allowed to enter in accordance with the work; and
performing control for regulating the entry of a person into the specified prohibited area in accordance with the time when the work is carried out.

### (Supplementary Note 16)

The control method according to Supplementary Note 15, comprising:
further specifying, in accordance with the time when the work is carried out, a control start time when the control is started; and
starting the control from the specified control start time.

### (Supplementary Note 17)

The control method according to Supplementary Note 15 or 16, comprising specifying, when the prohibited area is specified, the prohibited area associated with the work based on the work.

### (Supplementary Note 18)

The control method according to any one of Supplementary Notes 15 to 17, comprising:
further acquiring information indicating that a person is present in the prohibited area; and
changing the time when the work is carried out in accordance with the information indicating that the person is present in the prohibited area.

### (Supplementary Note 19)

The control method according to any one of Supplementary Notes 15 to 18, comprising transmitting, to equipment installed near the prohibited area, a control signal for regulating entry of a person when the control for regulating the entry of a person into the specified prohibited area is performed.

### (Supplementary Note 20)

The control method according to any one of Supplementary Notes 15 to 19, comprising turning on a lighting device installed near the prohibited area when the control for regulating the entry of a person into the specified prohibited area is performed.

### (Supplementary Note 21)

A program for causing a computer to execute:
acquiring information regarding work carried out by a mobile body and a time when the work is carried out;
specifying a prohibited area which a person is not allowed to enter in accordance with the work; and
performing control for regulating the entry of a person into the specified prohibited area in accordance with the time when the work is carried out.

### REFERENCE SIGNS LIST

11 ACQUISITION MEANS
12 SPECIFICATION MEANS
13 CONTROL MEANS
20 CONTROL APPARATUS
21 ACQUISITION UNIT
22 SPECIFICATION UNIT
23 CONTROL UNIT
24 MANAGEMENT UNIT
30 WIRELESS APPARATUS
40 CONTROL EQUIPMENT
50 NETWORK
60 SENSOR
70 CAMERA
80 CONTROL APPARATUS
81 DETERMINATION UNIT

What is claimed is:

1. A management system comprising:
at least one memory storing instructions, and
at least one processor configured to execute the instructions to;
acquire information on work carried out by a mobile body and a time when the work is carried out;
specify a prohibited area which a person is not allowed to enter in accordance with the work; and
perform control for regulating the entry of a person into the specified prohibited area in accordance with the time when the work is carried out.

2. The management system according to claim 1, wherein the at least one processor is further configured to execute the instructions to
specify, in accordance with the time when the work is carried out, a control start time when the control is started, and
start the control from the specified control start time.

3. The management system according to claim 2, wherein the control start time is set, based on the time when the work is carried out, a predetermined time before the time when the work is carried out.

4. The management system according to claim 1, wherein the at least one processor is further configured to execute the instructions to specify the prohibited area associated with the work based on the work.

5. The management system according to claim 1, wherein the at least one processor is further configured to execute the instructions to
acquire information indicating that a person is present in the prohibited area, and
change the time when the work is carried out in accordance with the information indicating that the person is present in the prohibited area.

6. The management system according to claim 1, wherein the at least one processor is further configured to execute the instructions to transmit, to equipment installed near the prohibited area, a control signal for regulating entry of a person.

7. The management system according to claim 1, wherein the at least one processor is further configured to execute the instructions to turn on a lighting device installed near the prohibited area.

8. The management system according to claim 1, wherein the at least one processor is further configured to execute the instructions to interrupt a path for entering the prohibited area.

9. A control apparatus comprising:
at least one memory storing instructions, and
at least one processor configured to execute the instructions to;
acquire information on work carried out by a mobile body and a time when the work is carried out;
specify a prohibited area which a person is not allowed to enter in accordance with the work; and
perform control for regulating the entry of a person into the specified prohibited area in accordance with the time when the work is carried out.

10. The control apparatus according to claim 9, wherein the at least one processor is further configured to execute the instructions to
specify, in accordance with the time when the work is carried out, a control start time when the control is started, and
start the control from the specified control start time.

11. The control apparatus according to claim 9, wherein the at least one processor is further configured to execute the instructions to specify the prohibited area associated with the work based on the work.

12. The control apparatus according to claim 9, wherein the at least one processor is further configured to execute the instructions to
acquire information indicating that a person is present in the prohibited area, and
change the time when the work is carried out in accordance with the information indicating that the person is present in the prohibited area.

13. The control apparatus according to claim 9, wherein the at least one processor is further configured to execute the instructions to transmit, to equipment installed near the prohibited area, a control signal for regulating entry of a person.

14. The control apparatus according to claim 9, wherein the at least one processor is further configured to execute the instructions to turn on a lighting device installed near the prohibited area.

15. A control method comprising:
acquiring information regarding work carried out by a mobile body and a time when the work is carried out;
specifying a prohibited area which a person is not allowed to enter in accordance with the work; and
performing control for regulating the entry of a person into the specified prohibited area in accordance with the time when the work is carried out.

16. The control method according to claim 15, comprising:
further specifying, in accordance with the time when the work is carried out, a control start time when the control is started; and
starting the control from the specified control start time.

17. The control method according to claim 15, comprising specifying, when the prohibited area is specified, the prohibited area associated with the work based on the work.

18. The control method according to claim 15, comprising:
further acquiring information indicating that a person is present in the prohibited area; and
changing the time when the work is carried out in accordance with the information indicating that the person is present in the prohibited area.

19. The control method according to claim 15, comprising transmitting, to equipment installed near the prohibited area, a control signal for regulating entry of a person when the control for regulating the entry of a person into the specified prohibited area is performed.

20. The control method according to claim 15, comprising turning on a lighting device installed near the prohibited area when the control for regulating the entry of a person into the specified prohibited area is performed.
